(19) United States
(12) Patent Application Publication
(10) Pub. No.: US 2011/0027600 A1
(43) Pub. Date: Feb. 3, 2011

(54) Fiber Bonding Compositions and Methods of Making and Using Same

(75) Inventors: Peter C. Hayes, Charlotte, NC (US); Robert Proulx, Charlotte, NC (US)

Correspondence Address: McKeon Meunier Carlin & Curfman LLC, 817 W. Peachtree Street, Suite 900, Atlanta, GA, 30308, US

(73) Assignee: BASF SE, Rheinland-Pfalz (DE)

(21) Appl. No.: 12/849,179

(22) Filed: Aug. 3, 2010

Related U.S. Application Data
(60) Provisional application No. 61/230,891, filed on Aug. 3, 2009.

(51) Int. Cl. B32B 27/30; C08L 33/04; C08L 33/20; B05D 3/02

(52) U.S. Cl. 428/500; 524/523; 524/521; 427/385.5

(57) ABSTRACT

Fiber bonding compositions are provided comprising a polymer dispersion comprising two or more of a first polymer selected from the group consisting of styrene acrylics and straight acrylics and having a T_{g} from about 35° C. to about 45° C., a second polymer selected from the group consisting of styrene acrylics and straight acrylics and having a T_{g} from about −12° C. to about −2° C., and a third polymer selected from the group consisting of styrene acrylics and straight acrylics and having a T_{g} from about −28° C. to about −18° C. Methods of making a fiber bonding composition, methods of coating or saturating a fiber substrate, and coated or saturated fiber substrates are also provided.

### CROSS-REFERENCE TO RELATED APPLICATIONS

The present application claims priority to U.S. Provisional Patent Application No. 61/230,891, filed Aug. 3, 2009, which is incorporated herein by reference in its entirety.

### TECHNICAL FIELD

This invention relates to fiber bonding, and more particularly to fiber bonding with blended polymers.

### BACKGROUND

Polymeric fiber bonding compositions are formulated to bind various types of fibers in the manufacture of coated fiber substrates. For example, glass fiber bonding compositions are used in the production of insulation materials, and cellulose bonding compositions are used in the production of coated paper and saturated paper. A paper coating using a blend of a vinyl aromatic-acrylic polymer dispersion with a vinyl aromatic-diene polymer dispersion is described in U.S. Pat. No. 6,884,468 to Abundis et al., which is incorporated by reference herein in its entirety.

### SUMMARY

In one aspect, a fiber bonding composition includes a polymer dispersion including two or more of: a first polymer selected from the group consisting of styrene acrylics and straight acrylics and having a T_{g} from about 35° C. to about 45° C.; a second polymer selected from the group consisting of styrene acrylics and straight acrylics and having a T_{g} from about −12° C. to about −2° C.; and a third polymer selected from the group consisting of styrene acrylics and straight acrylics and having a T_{g} from about −28° C. to about −18° C.

In some implementations, at least the first polymer, the second polymer, or the third polymer present in the composition is a straight acrylic and the straight acrylic can be derived from monomers including butyl acrylate and methyl methacrylate. In some implementations, at least the first polymer, the second polymer, or the third polymer present in the composition is a styrene acrylic and the styrene acrylic can be derived from monomers comprising butyl acrylate and styrene. In some implementations, at least the first polymer, the second polymer, or the third polymer present in the composition is derived from monomers including (meth)acrylonitrile. At least the first polymer, the second polymer, or the third polymer can have a (meth)acrylonitrile content of from greater than 0 wt % to about 20 wt % or from about 5 wt % to about 15 wt %.

In certain implementations, at least the first polymer, the second polymer, or the third polymer present in the composition is derived from monomers including an internal crosslinker. The internal crosslinker can be selected from the group consisting of di(meth)acrylates, tri(meth)acrylates, and mixtures thereof. In some cases, the internal crosslinker includes butanediol diacrylate. In some implementations, at least the first polymer, the second polymer, or the third polymer present in the composition is derived from a crosslinker in an amount from greater than 0 wt % to about 2 wt %, or from about 0.2 wt % to about 1.5 wt %. In some implementations, the fiber bonding composition includes an external crosslinker. The external crosslinker can include N-methylol (meth)acrylamide.

In certain implementations, the fiber bonding composition can include 5-95% of the first polymer, 5-95% of the second polymer, and 0-25% of the third polymer, by weight based on the total polymer content. In some embodiments, the first polymer, the second polymer, and the third polymer can be derived from monomers including (meth)acrylic acid and/or esters thereof, (meth)acrylonitrile, crosslinkers, and optionally vinyl aromatic monomers. In some cases, the first polymer, the second polymer, and the third polymer present in the composition can be derived from monomers including butyl acrylate, acrylonitrile, butanediol diacrylate, and one or more of styrene and methyl methacrylate. In some implementations, the fiber bonding composition can include one or more of a urea formaldehyde resin and a melamine formaldehyde resin. For example, the composition can include from about 1 wt % to about 30 wt %, or about 5 wt % to about 10 wt %, urea formaldehyde resin, melamine formaldehyde resin, or mixtures thereof. In some cases, a gel content of the polymers included in the composition is from about 60% to about 90%.

In some fiber bonding compositions, the T_{g} of the first polymer is from about 38° C. to about 42° C., the T_{g} of the second polymer is from about −9° C. to about −5° C., and the T_{g} of the third polymer is from about −25° C. to about −21° C.

In some implementations, the fiber bonding composition includes a mixture of two or more of: (i) a first polymer dispersion comprising a first polymer selected from the group consisting of styrene acrylics and straight acrylics and having a T_{g} from about 35° C. to about 45° C.; (ii) a second polymer dispersion comprising a second polymer selected from the group consisting of styrene acrylics and straight acrylics and having a T_{g} from about −12° C. to about −2° C.; and (iii) a third polymer dispersion comprising a third polymer selected from the group consisting of styrene acrylics and straight acrylics and having a T_{g} from about −28° C. to about −18° C.

In another aspect, making a fiber bonding composition includes selecting two or more polymers from the group consisting of: (a) a first polymer selected from the group consisting of styrene acrylics and straight acrylics and having a T_{g} from about 35° C. to about 45° C.; (b) a second polymer selected from the group consisting of styrene acrylics and straight acrylics and having a T_{g} from about −12° C. to about −2° C.; and (c) a third polymer selected from the group consisting of styrene acrylics and straight acrylics and having a T_{g} from about −28° C. to about −18° C.; and forming a polymer dispersion including the selected polymers.

In another aspect, coating or saturating a fiber substrate includes applying a composition to the fiber substrate and heating the substrate. The composition can include a polymer dispersion having two or more of: (a) a first polymer selected from the group consisting of styrene acrylics and straight acrylics and having a T_{g} from about 35° C. to about 45° C.; (b) a second polymer selected from the group consisting of styrene acrylics and straight acrylics and having a T_{g} from about −12° C. to about −2° C.; and (c) third polymer selected from the group consisting of styrene acrylics and straight acrylics and having a T_{g} from about −28° C. to about −18° C.

In another aspect, a coated or saturated fiber substrate includes a fiber substrate and a composition bonded to the fiber substrate. The composition can include a polymer dispersion having two or more of: (a) a first polymer selected from the group consisting of styrene acrylics and straight acrylics and having a T_{g} from about 35° C. to about 45° C.; (b) a second polymer selected from the group consisting of styrene acrylics and straight acrylics and having a T_{g} from about −12° C. to about −2° C.; and (c) a third polymer selected from the group consisting of styrene acrylics and straight acrylics and having a T_{g} from about −28° C. to about −18° C.

The details of one or more embodiments are set forth in the accompanying drawings and the description below. Other features, objects, and advantages will be apparent from the description and drawings, and from the claims.

### DESCRIPTION OF DRAWINGS

FIG. 1 shows tensile strength for a polyester web coated with various polymer dispersions.

FIG. 2 shows % elongation for a polyester web coated with various polymer dispersions.

FIG. 3 shows hot elongation for a polyester web coated with various polymer dispersions.

FIG. 4 shows dry tensile strength for paper coated with various polymer dispersions.

FIG. 5 shows predicted means for tensile strength (dry) for filter paper coated with various polymer dispersions.

FIG. 6 is a plot of marginal means for % elongation (dry) for filter paper coated with various polymer dispersions.

FIG. 7 shows predicted means for % elongation (wet) for filter paper coated with various polymer dispersions.

FIG. 8 shows predicted means for perchloroethylene absorption for dried polymer films formed from various polymer dispersions.

FIG. 9 shows predicted means for tensile strength (dry) for filter paper coated with various polymer dispersions.

FIG. 10 shows predicted means for tensile strength (wet) for filter paper coated with various polymer dispersions.

FIG. 11 shows predicted means for % elongation (wet) for filter paper coated with various polymer dispersions.

FIG. 12 shows predicted means for solvent absorption for dried polymer films formed from various polymer dispersions.

FIG. 13 is a plot of dry tensile strength for filter paper coated with various blended fiber bonding compositions.

FIG. 14 is a plot of % elongation (dry) for filter paper coated with various blended fiber bonding compositions.

FIG. 15 is a plot of tensile strength (wet) for filter paper coated with various blended fiber bonding compositions.

FIG. 16 is a plot of % elongation (wet) for filter paper coated with various blended fiber bonding compositions.

FIG. 17 is a plot of perchloroethylene absorption for films formed from various blended fiber bonding compositions.

FIG. 18 is a plot of water absorption for films formed from various blended fiber bonding compositions.

FIG. 19 is a plot of tensile strength (dry) for filter paper coated with various blended fiber bonding compositions.

FIG. 20 is a plot of % elongation (wet) for filter paper coated with various blended fiber bonding compositions.

FIG. 21 is a plot of water absorbance for films formed from various blended fiber bonding compositions.

### DETAILED DESCRIPTION

The term “comprising” and variations thereof as used herein are used synonymously with the term “including” and variations thereof and are open, non-limiting terms.

A blended fiber bonding composition can be formulated from a polymer dispersion including two or more polymers with different glass transition temperatures (T_{g}). Altering the ratio of the polymers with different glass transition temperatures in the blended composition allows fiber bonding compositions with a range of properties to be formulated from two or more polymers or polymer dispersions, facilitating rapid formulation of a variety of bonding compositions with a range of properties. The two or more polymers in the blended composition can each have a T_{g} of, for example, 40° C.±3-5° C., −7° C.±3-5° C., or −23° C.±3-5° C. In some embodiments, the two or more polymers in the blended composition can each have a T_{g} of 40° C.±2° C., −7° C.±2° C., or −23° C.±2° C.

Exemplary blended fiber bonding compositions include a mixture of at least two polymers, or at least two dispersions including polymers, selected from: a first polymer having a T_{g} from about 35° C. to about 45° C. or from about 38° C. to about 42° C., a second polymer having a T_{g} from about −12° C. to about −2° C. or from about −9° C. to about −5° C., and a third polymer having a T_{g} from about −28° C. to about −18° C. or from about −25° C. to about −21° C. In some embodiments, the fiber bonding composition includes 5-95 wt % of the first polymer, 5-95 wt % of the second polymer, and 0-25 wt % of the third polymer, based on the total polymer content. In some embodiments, the total dry polymer content in the composite including the fibers and the polymer bonding composition ranges from about 5 wt % to about 35 wt %, from about 10 wt % to about 30 wt %, from about 15 wt % to about 25 wt %, or from about 19 wt % to about 21 wt % (e.g. 20 wt %), based on the total dry weight of the composite.

In some embodiments, the polymers used in the fiber bonding composition can be formed from unsaturated monomers. The unsaturated monomers can be ethylenically unsaturated monomers such as α,β-monoethylenically unsaturated mono and dicarboxylic acids or anhydrides thereof (e.g. acrylic acid, methacrylic acid, crotonic acid, dimethacrylic acid, ethylacrylic acid, allylacetic acid, vinylacetic acid maleic acid, fumaric acid, itaconic acid, mesaconic acid, methylenemalonic acid, citraconic acid, maleic anhydride, itaconic anhydride, and methylmalonic anhydride); esters of α,β-monoethylenically unsaturated mono and dicarboxylic acids having 3 to 6 carbon atoms with alkanols having 1 to 12 carbon atoms (e.g. esters of acrylic acid, methacrylic acid, maleic acid, fumaric acid, or itaconic acid, with C1-C12, C1-C8, or C1-C4 alkanols such as methyl, ethyl, n-butyl, isobutyl and 2-ethylhexyl acrylates and methacrylates, dimethyl maleate and n-butyl maleate); (meth)acrylonitrile; vinylaromatic compounds (e.g. styrene, α-methylstyrene, o-chlorostyrene, and vinyltoluenes); 1,2-butadiene (i.e. butadiene); acrylamides and alkyl-substituted acrylamides (e.g. (meth)acrylamide, N-tert-butylacrylamide, and N-methyl(meth)acrylamide); conjugated dienes (e.g. 1,3-butadiene and isoprene) vinyl and vinylidene halides (e.g. vinyl chloride and vinylidene chloride); vinyl esters of C1-C18 mono or dicarboxylic acids (e.g. vinyl acetate, vinyl propionate, vinyl n-butyrate, vinyl laurate and vinyl stearate); C1-C4 hydroxyalkyl esters of C3-C6 mono or dicarboxylic acids, especially of acrylic acid, methacrylic acid or maleic acid, or their derivatives alkoxylated with from 2 to 50 moles of ethylene oxide, propylene oxide, butylene oxide or mixtures thereof, or esters of these acids with C1-C18 alcohols alkoxylated with from 2 to 50 moles of ethylene oxide, propylene oxide, butylene oxide or mixtures thereof (e.g. hydroxyethyl (meth)acrylate, hydroxypropyl (meth)acrylate, and methylpolyglycol acrylate); and monomers containing glycidyl groups (e.g. glycidyl methacrylate).

A polymer in a blended fiber bonding composition can be derived from monomers including an internal crosslinker. The internal crosslinkers can include N-alkylolamides of α,β-monoethylenically unsaturated carboxylic acids having 3 to 10 carbon atoms and esters thereof with alcohols having 1 to 4 carbon atoms (e.g. N-methylolacrylamide and N-methylolmethacrylamide); glyoxal based crosslinkers; monomers containing two vinyl radicals; monomers containing two vinylidene radicals; and monomers containing two alkenyl radicals. Exemplary crosslinking monomers include diesters or triesters of dihydric and trihydric alcohols with α,β-monoethylenically unsaturated monocarboxylic acids (e.g. di(meth)acrylates, tri(meth)acrylates), of which in turn acrylic acid and methacrylic acid can be employed. Examples of such monomers containing two non-conjugated ethylenically unsaturated double bonds are alkylene glycol diacrylates and dimethacrylates, such as ethylene glycol diacrylate, 1,3-butylene glycol diacrylate, 1,4-butylene glycol diacrylate and propylene glycol diacrylate, divinylbenzene, vinyl methacrylate, vinyl acrylate, allyl methacrylate, allyl acrylate, diallyl maleate, diallyl fumarate and methylenebisacrylamide. In some embodiments, the crosslinking monomers include alkylene glycol diacrylates and dimethacrylates, and/or divinylbenzene. In some embodiments, the internal crosslinker can be, for example, a di(meth)acrylate, a tri(meth)acrylate, or any mixture thereof. In some embodiments, the internal crosslinker includes butanediol diacrylate.

In addition to the crosslinking monomers, small amounts (e.g. from 0.01 to 4% by weight based on the total monomer weight) of molecular weight regulators, such as tert-dodecyl mercaptan, can be used. Such substances are preferably added to the polymerization zone in a mixture with the monomers to be polymerized and are considered part of the total amount of unsaturated monomers used in the polymer.

In some embodiments, the polymers are typically derived from monomers including (meth)acrylic acid and/or esters thereof, and optionally one or more of (meth)acrylonitrile, internal crosslinkers, and vinyl aromatic monomers. In some embodiments, at least one of the polymers has a (meth)acrylonitrile content of from greater than 0 wt % to about 20 wt %, or from about 5 wt % to about 15 wt %. The crosslinkers, when included in the polymer, can be provided in an amount from greater than 0 wt % to about 2 wt %, or from about 0.2 wt % to about 1.5 wt %.

The polymers in the fiber bonding composition can be, for example, styrene acrylics, straight acrylics, styrene butadiene copolymers or any mixture thereof. The choice of the styrene acrylic and straight acrylic can depend on what the target T_{g} is for the particular polymer and the properties desired for the particular polymer. Furthermore, this can also be the basis for selecting particular (meth)acrylic acids and/or esters thereof for use in the polymers, and for including either (meth)acrylonitrile or internal crosslinkers.

The straight acrylics can be derived from monomers. In some embodiments, the copolymer can be a straight acrylic copolymer derived from monomers including (meth)acrylic acid, (meth)acrylic acid esters, (meth)acrylamide, (meth)acrylonitrile, and mixtures thereof. For example, the straight acrylic copolymer can include at least one of (meth)acrylic acid, itaconic acid, methyl(meth)acrylate, ethyl(meth)acrylate, n-butyl(meth)acrylate, isobutyl (meth)acrylate, tert-butyl (meth)acrylate, 2-ethylhexyl (meth)acrylate, (meth)acrylamide, (meth)acrylonitrile, and hydroxyethyl (meth)acrylate. In some embodiments, the straight acrylic polymer can include butyl acrylate and methyl methacrylate, and optionally (meth)acrylonitrile and/or internal crosslinkers.

The styrene acrylic can include the monomers described above for the straight acrylics and can include a vinyl aromatic monomer such as styrene. In some embodiments, the styrene acrylic can be derived from monomers including styrene, one or more of butyl acrylate and methyl methacrylate, and optionally (meth)acrylonitrile and/or internal crosslinkers. In certain embodiments, the polymers can be derived from butyl acrylate, acrylonitrile (AN), butanediol diacrylate (BDDA), and one or more of styrene and methyl methacrylate.

The styrene butadiene copolymer can be derived from monomers including styrene, butadiene, (meth)acrylamide, (meth)acrylonitrile, itaconic acid and (meth)acrylic acid. The styrene butadiene copolymer can include from 40 to 75% by weight of styrene, from 25 to 60% by weight of butadiene, 1 to 10% of itaconic and/or (meth)acrylic acid, 0 to 3% by weight of (meth)acrylamide, and 0 to 20% by weight (meth)acrylonitrile. The styrene butadiene copolymer can also include from 0 to 5% by weight of one or more crosslinking monomers as described above such as divinylbenzene.

In some embodiments, a gel content of the polymers in the fiber bonding composition is from about 60% to about 90%, or from about 75% to about 85%.

A blended fiber bonding composition can include an external crosslinker. For example, one of the polymers in the composition can be derived from monomers including an external crosslinker. The external crosslinker can include, for example, N-methylol (meth)acrylamide. The external crosslinker can be selected to have the ability to react with the polymers, the fibers, or both. The external crosslinker can improve properties of the coated or saturated substrate, including water resistance and solvent resistance.

Blended fiber bonding compositions can be used to coat or saturate fiber substrates such as, for example, glass, polyester, and cellulose. A fiber bonding composition can be formulated to suit the intended substrate. For example, a fiber bonding composition formulated for more rigid fibers, such as glass fibers, may have a greater ratio of high T_{g} polymer (e.g., T_{g}˜40° C.) to medium T_{g} (e.g., T_{g}˜−7° C.) polymer or low T_{g} polymer (e.g., T_{g}˜−23° C.) than a fiber bonding composition formulated for softer fibers, such as cellulose fibers. The blended fiber bonding composition can have a target value for the average T_{g} of from −2 to 35° C.

A fiber bonding composition can be formed by mixing two or more polymers, or two or more polymer dispersions, as described above. A substrate can be coated (e.g., saturated) with the fiber bonding composition. The composition can be cured by heating the coated or saturated substrate above the polymerization temperature of the bonding composition. Crosslinkers present in the bonding composition may react to form bonds between the polymers, fibers, or both once the bonding composition is heated above the polymerization temperature (e.g., 150° C.).

A blended fiber bonding composition can also include one or more resins, such as a urea formaldehyde resin and a melamine formaldehyde resin. The presence of a resin in the polymer dispersion can increase the stiffness of the coated or saturated substrate. In some embodiments, a blended fiber bonding composition includes about 1 wt % to about 30 wt % or about 5 wt % to about 10 wt % urea formaldehyde resin, melamine formaldehyde resin, or any mixture thereof.

Coated or saturated fiber substrates described herein can be used as cloth wipes such as fabric softeners, roofing felts, building materials such as cement and gypsum boards, and saturated paper webs or substrates for industrial or masking tapes, paper towels and wipes.

The following examples are provided to more fully illustrate some of the embodiments of the present invention. It should be appreciated by those of skill in the art that the techniques disclosed in the examples which follow represent techniques discovered by the inventors to function well in the practice of the invention, and thus can be considered to constitute exemplary modes for its practice. However, those of skill in the art should, in light of the present disclosure, appreciate that many changes can be made in the specific embodiments that are disclosed and still obtain a like or similar result without departing from the spirit and scope of the invention.

TABLE I lists compositions that can be used to form polymers with glass transition temperatures of about 40° C.±2° C., about −7° C.±2° C., and about −23° C.±2° C., respectively. Parts are on a per weight basis unless indicated otherwise.

TABLE I
Polymer Dispersions for Blended Fiber Bonding Compositions

| Material | T_{g} = 40 ± 2° C. | T_{g} = −7 ± 2° C. | T_{g} = −23 ± 2° C. |
|---|---|---|---|
| Styrene, parts | 42-46(43.5) | 8-14(10.5) | 0 |
| Butyl acrylate, parts | 40-44(42) | 72-78(75) | 83-89(85.5) |
| Acrylonitrile (AN), parts | 0-10 | 0-10 | 0-10 |
| Itaconic/acrylic acid, parts | 0.5/1.5 | 0.5/1.5 | 0.5/1.5 |
| Butanediol diacrylate (BDDA), parts | 0-0.5 | 0-0.5 | 0-0.5 |
| N-Methylol acrylamide, parts | 0-3.0(2.0) | 0-3.0(2.0) | 0-3.0(2.0) |
| Ammonium persulfate, parts | 0.8-1.0 | 0.8-1.0 | 0.8-1.0 |
| NaOH (pre-emulsion charge), parts | 0.11 | 0.11 | 0.11 |
| Solids | 45-50%, pH 5-7 | 45-50%, pH 5-7 | 45-50%, pH 5-7 |
| Polymerization temp./time | 85° C./4.5 h | 85° C./4.5 h | 85° C./4.5 h |

High, medium and low T_{g} polymer dispersions were prepared as described below in Table II. A standard seeded carboxy-methyl-amylose (continuous monomer addition) process was employed with a target particle size of 165 nm. In each case, the itaconic acid and 10% of the persulfate was added in the initial charge. The pH was adjusted with NaOH. The polymerization occurred over 4.5 hrs. The monomers were fed over the first 3.5 hrs, persulfate was fed over the next 0.5 hrs, and polymerization was allowed to occur for another 0.5 hrs to reduce monomer count. Dispersions produced had low coagulum levels with viscosities in the range of 100-450 mPa·s. Exemplary properties for the three polymer dispersions are also provided in Table II.

TABLE II
Exemplary Polymer Dispersions for Blended Fiber
Bonding Compositions and Resultant Properties

| Material | High T_{g} | Medium T_{g} | Low T_{g} |
|---|---|---|---|
| T_{g}(° C.) | 39 | −7 | −21 |
| Styrene, parts | 43.5 | 10.5 | 0 |
| Butyl acrylate, parts | 42 | 75 | 85.5 |
| Acrylonitrile (AN), parts | 10 | 10 | 10 |
| Itaconic/acrylic acid, | 0.5/1.5 | 0.5/1.5 | 0.5/1.5 |
| parts | | | |
| Butanediol diacrylate | 0.5 | 0.5 | 0.5 |
| (BDDA), parts | | | |
| N-Methylol acrylamide, | 2.0 | 2.0 | 2.0 |
| parts | | | |
| Ammonium persulfate, parts | 0.8 | 0.8 | 0.8 |
| NaOH (PE), parts | 0.11 | 0.11 | 0.11 |
| Solids | 48% | 49% | 46% |
| pH | 6.5 | 6.5 | 6.5 |
| Viscosity (mPa · s) | 181 | 334 | 100 |
| Temp./polymerization time | 85° C./4.5 h | 85° C./4.5 h | 85° C./4.5 h |

The experimental design type used to assess the impact of AN and BDDA in various polymer dispersions was a standard 2² factorial using AN levels of 0 and 10 parts and BDDA levels of 0 and 0.5 parts with replication resulting in eight dispersions for each T_{g} level (high: ˜40° C.±2° C., medium: ˜−7° C.±2° C., and low: ˜−23° C.±2° C.) and a total of 24 dispersions. The effect of the variables of AN (0 and 10 parts) and BDDA (0 and 0.5 parts) were evaluated for properties of polymer films and specific application properties. STATISTICA® experimental design software (StatSoft, Inc.) was used for data analysis and graph generation.

The T_{g} for each dispersion was achieved within the limits of ±2° C. by adjusting styrene/butyl acrylate ratios. Correlation coefficients were between 0.89 and 0.99, indicating a good fit of the regression model to the experimental data. Target polymer content was 20% in the composite.

Application testing was conducted on paper and polyester substrates. Some polymer dispersions were compared with ACRONAL® 5888 (a styrene acrylic dispersion comprising acrylonitrile that is commercially available from BASF and that has a T_{g} of 31° C.) and PRIMAL® TR 407 (a self-crosslinking straight acrylic dispersion comprising acrylonitrile that is commercially available from Rohm and Haas and that has a T_{g} of 34° C.).

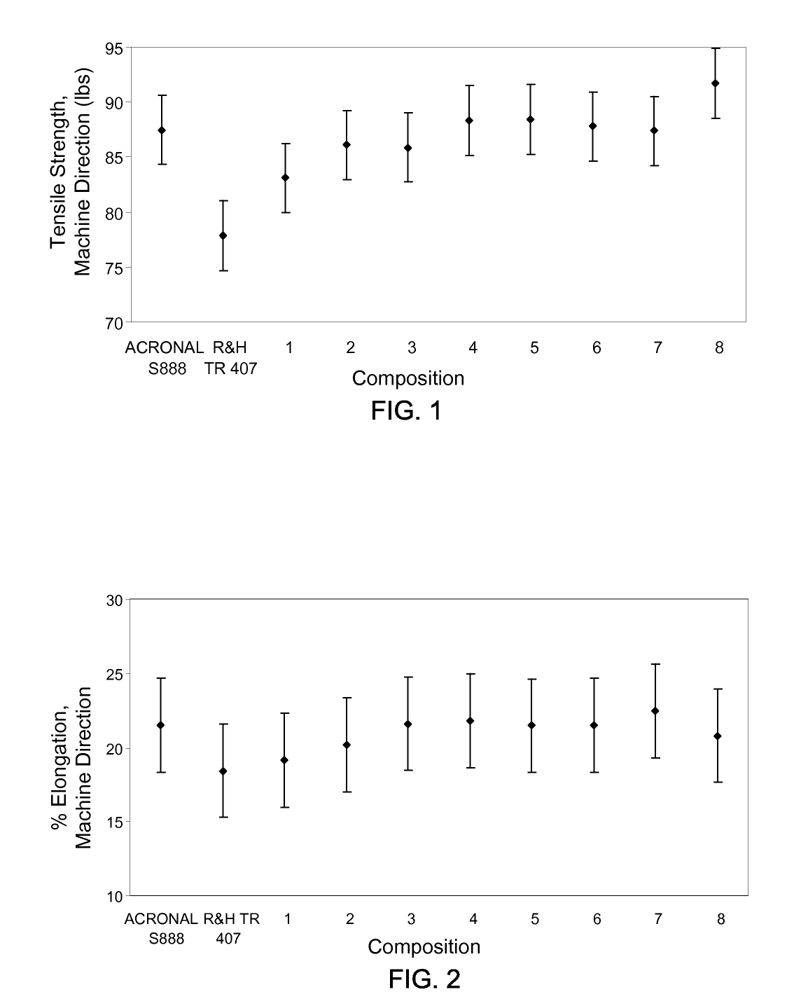

FIGS. 1-4 show various properties of ACRONAL® 5888, PRIMAL® TR 407, and polymer dispersions 1-8 with T_{g}˜40° C. The amount of AN in polymer dispersions 1-8 was 0, 0, 0, 0, 10, 10, 10, and 10 parts respectively. The amount of BDDA in polymer dispersions 1-8 was 0.5, 0.5, 0, 0, 0, 0, 0.5, and 0.5, respectively. The 10% AN and 0.5% BDDA dispersions resulted in coated fiber substrates with a higher degree of crosslinking

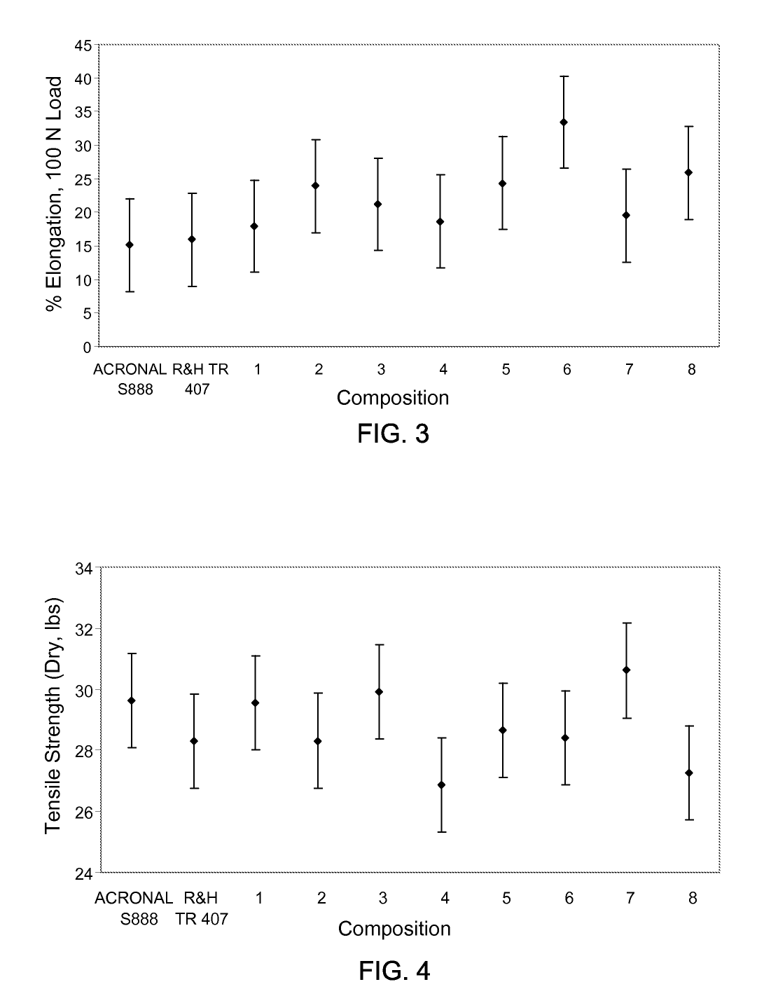

FIG. 1 shows machine direction (MD) tensile strength for coated polyester web, with maximum load in the machine direction on the y axis (lbs), and coating composition (ACRONAL® S888, PRIMAL® TR 407, and polymer dispersions 1-8) identified on the x axis. FIG. 2 shows percent elongation at maximum load in the machine direction for coated polyester web, with percent elongation on the y axis and coating composition (ACRONAL® S888, PRIMAL® TR 407, and polymer dispersions 1-8) identified on the x axis. FIG. 3 shows hot elongation in the cross direction (CD) for coated polyester web, with percent elongation on the y axis and coating composition (ACRONAL® S888, PRIMAL® TR 407, and polymer dispersions 1-8) identified on the x axis. FIG. 4 shows tensile strength in lbs on the y axis for dry Whatman paper (Grade 4 filter paper substrates available from Whatman Schleicher & Schuell (Kent, UK), Category # 1004-917) coated with the coating composition (ACRONAL® S888, PRIMAL® TR 407, and polymer dispersions 1-8) identified on the x axis. Tensile strength, hot and cold elongation, and tear strength data did not vary significantly within the experimental design space (levels of AN and BDDA). However, the presence of AN and BDDA improved performance in the medium T_{g} dispersions used in roofing applications as well as in low T_{g} dispersions.

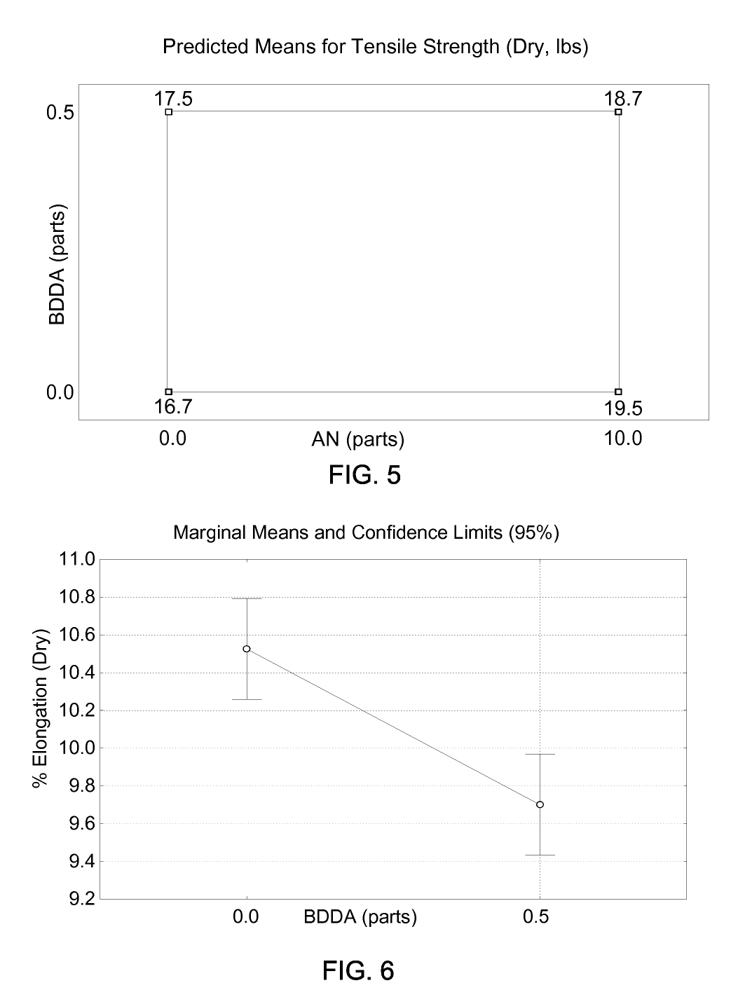

Medium T_{g} polymer dispersions (T_{g}˜−7° C.) listed in Table 1 were coated on Grade 4 Whatman filter paper substrates. Predicted and measured properties of these coated paper substrates are shown in FIGS. 5-8. Statistically significant effects for dry and wet tensile strength and % elongation factors were observed. FIG. 5 shows predicted means, including main effects and two-way interactions, for dry tensile strength (lbs) for Whatman paper coated with the medium T_{g} polymer dispersion with AN 0 and 10 parts, and BDDA 0 and 0.5 parts. For example, for 0 parts AN and 0.5 parts BDDA, the predicted mean for dry tensile strength is 17.5 lbs. AN incorporation was shown to increase tensile strength.

FIG. 6 is a plot of marginal means and confidence limits (95%) for % elongation (dry) of Whatman paper coated with the medium T_{g} polymer dispersion with parts BDDA on the x axis. This plot shows the effect of BDDA content with AN content held constant, indicating a decrease in % elongation with an increase in BDDA.

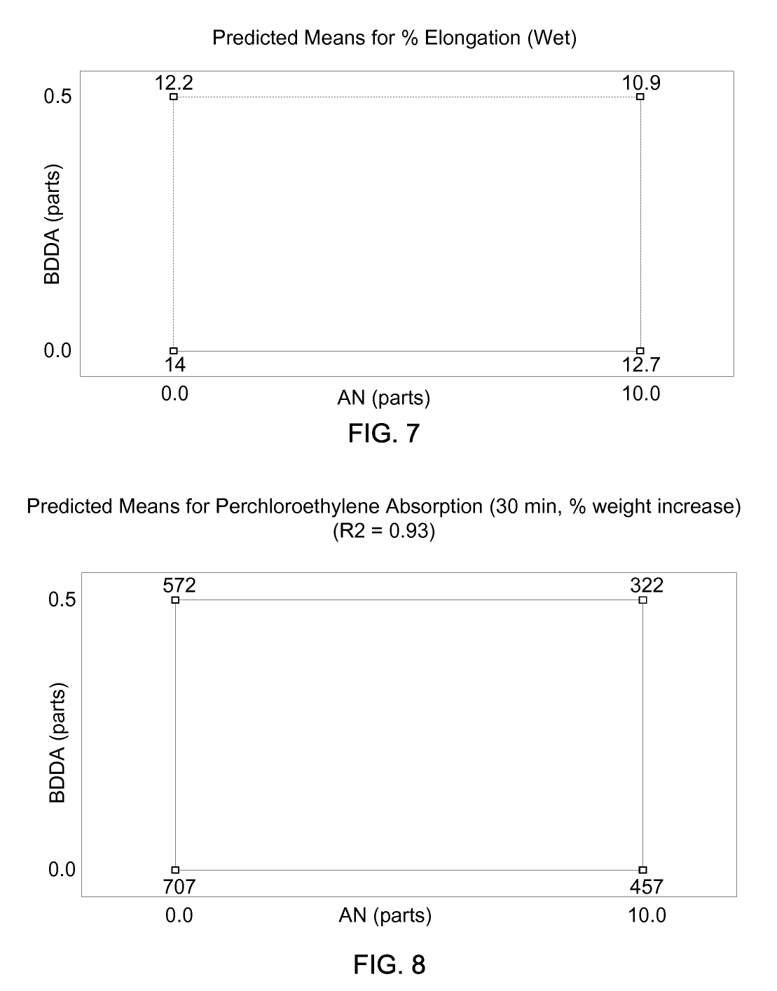

FIG. 7 shows predicted means for % elongation (wet) for Whatman paper coated with the medium T_{g} polymer dispersion with 0 parts BDDA and 0 parts AN (predicted mean 14% wet elongation); 0 parts BDDA and 10.0 parts AN (predicted mean 12.7% wet elongation); 0.5 parts BDDA and 0 parts AN (predicted mean 12.2%); and 0.5 parts BDDA and 10.0 parts AN (predicted mean 10.9%). BDDA was shown to reduce % wet elongation as well as % dry elongation.

FIG. 8 shows predicted means for perchloroethylene (solvent) absorption (in % weight increase) of dried polymer films formed from medium T_{g} polymer dispersions (AN 0 and 10 parts, BDDA 0 and 0.5 parts) after immersion for 30 minutes in an excess of perchloroethylene at room temperature. As seen in FIG. 8, solvent resistance was highest (i.e., perchloroethylene absorption was lowest) for a dried polymer film with a composition including 10% AN and 0.5% BDDA.

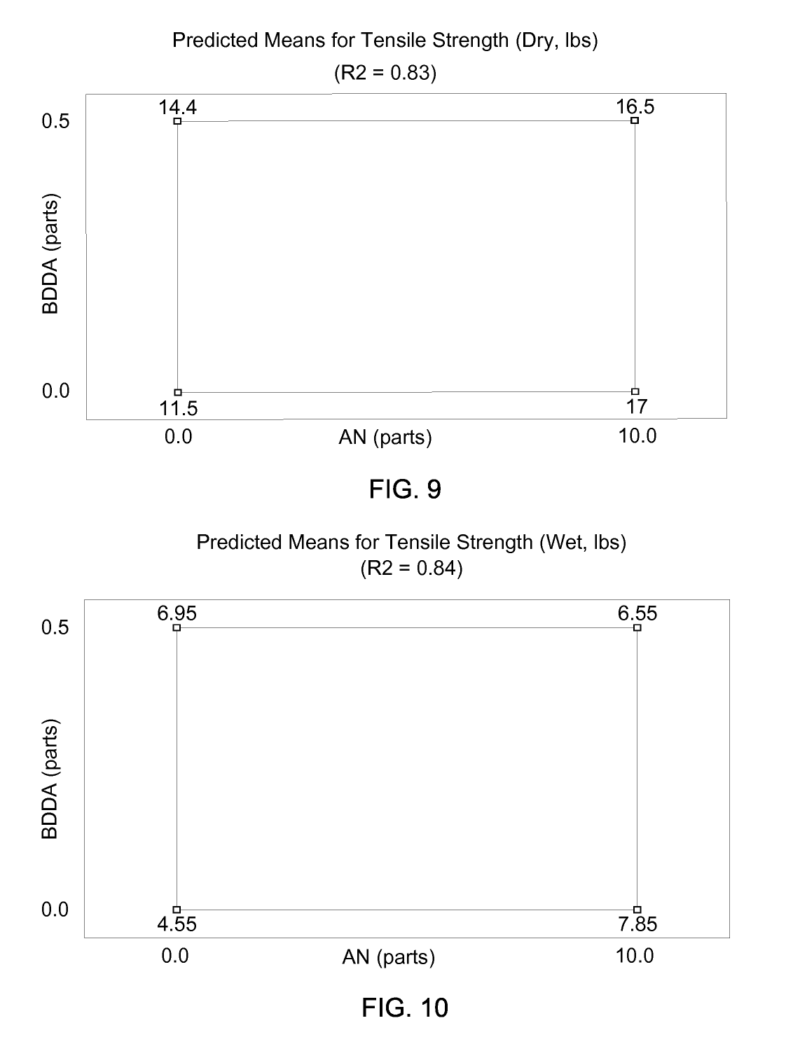

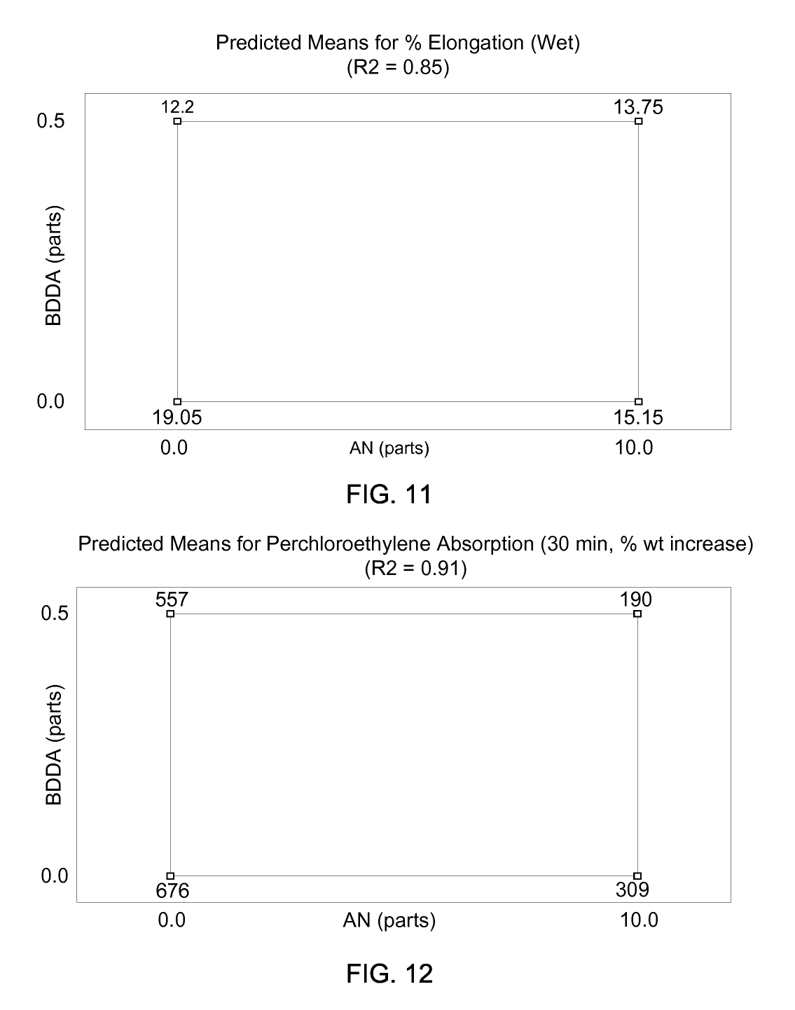

FIGS. 9-12 show various properties of low T_{g} polymer dispersions (T_{g}˜−23° C.), with AN 0 and 10 parts and BDDA 0 and 0.5 parts, coated on Whatman paper. FIGS. 9 and 10 show predicted means for dry and wet tensile strength (in lbs) of coated Whatman paper, respectively, including main effects and 2-way interactions. FIG. 11 shows predicted means for % elongation (wet) of coated Whatman paper, including main effects and 2-way interactions for compositions including 0 and 10 parts AN and 0 and 0.5 parts BDDA. FIG. 12 shows predicted means for perchloroethylene absorption (in % weight increase) of dried polymer films formed from low T_{g} polymer dispersions after soaking the films in an excess of perchloroethylene for 30 minutes at room temperature. The solvent resistance of polymer films showed dependence on AN content and cross-linking (BDDA) in that solvent resistance was highest (absorption was lowest) for 10% AN and 0.5% BDDA.

Analysis of the data from the polymer dispersions described above showed that the crosslinking for the 24 individual dispersions (low, medium, and high T_{g} dispersions, each with the amounts of AN and BDDA given above for polymer dispersions 1-8) was correlated in a linear fashion with the dry and wet tensile strengths and % elongation values.

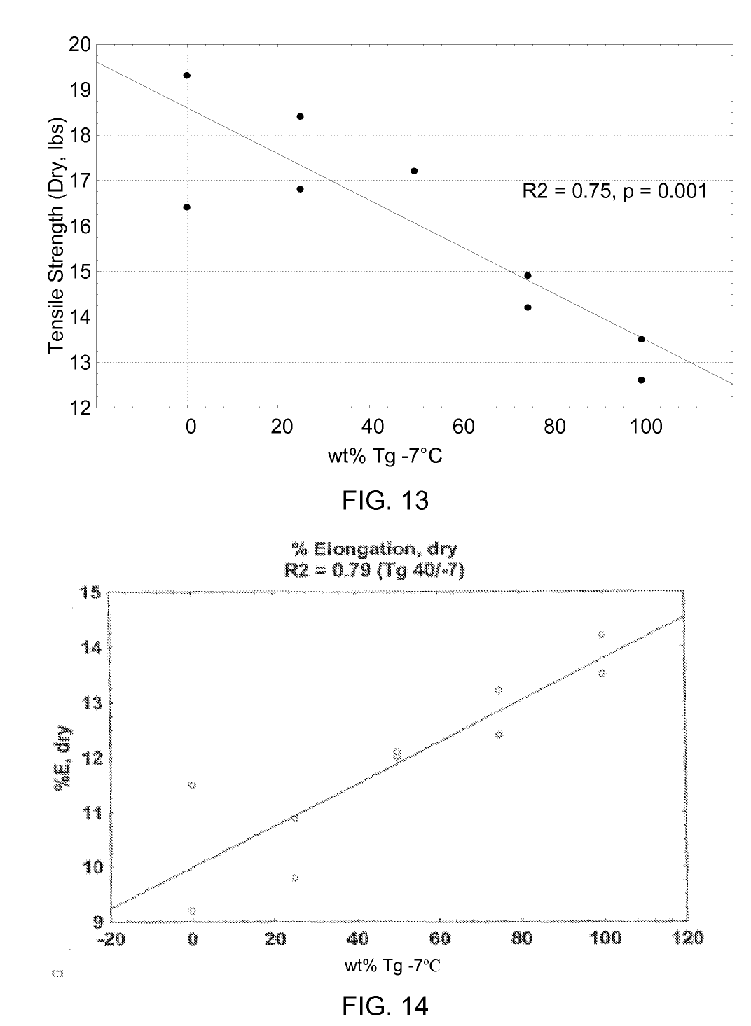

Blending experiments were performed with dispersions listed in TABLE II, i.e., high, medium, and low T_{g} dispersions with 10% AN and 0.5% BDDA. Reproducibility work was done on a one-gallon scale to show that the process was controllable in terms of particle size and coagulum levels. Binary mixtures of polymer dispersions were prepared with high/medium T_{g} polymer dispersions (40° C./−7° C.) and medium/low T_{g} polymer dispersions (−7° C./−23° C.). FIGS. 13-21 show properties of these blended polymer fiber bonding compositions.

For the measurements illustrated in FIGS. 13-18, mixtures at five levels (100 wt % −7° C. T_{g} polymer; 75 wt % −7° C. T_{g} polymer/25 wt % 40° C. T_{g} polymer; 50 wt % −7° C. T_{g} polymer/50 wt % 40° C. T_{g} polymer; 25 wt % −7° C. T_{g} polymer/75 wt % 40° C. T_{g} polymer; and 100 wt % 40° C. T_{g} polymer) were duplicated to give a total of 10 experiments for each design. Individual data points were an average of 10 measurements for tensile properties and two for water and solvent tests.

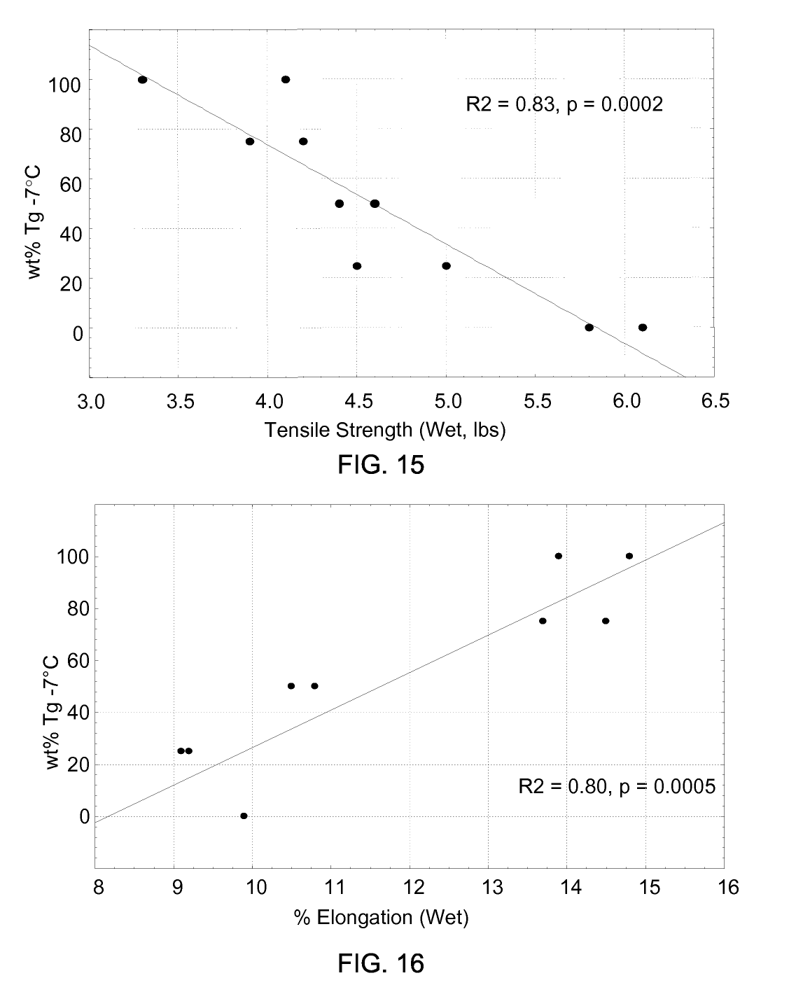

For the tests in FIGS. 13-16, Grade 4 Whatman filter paper substrates were coated with the mixtures. FIG. 13 shows dry tensile strength (lbs) vs. wt % −7° C. T_{g} polymer. FIG. 14 shows % elongation (dry) vs. wt % −7° C. T_{g} polymer. FIG. 15 shows wet tensile strength (lbs) on the x axis, with wt % −7° C. T_{g} polymer on the y axis. FIG. 16 shows wt % −7° C. T_{g} polymer vs. % elongation (wet).

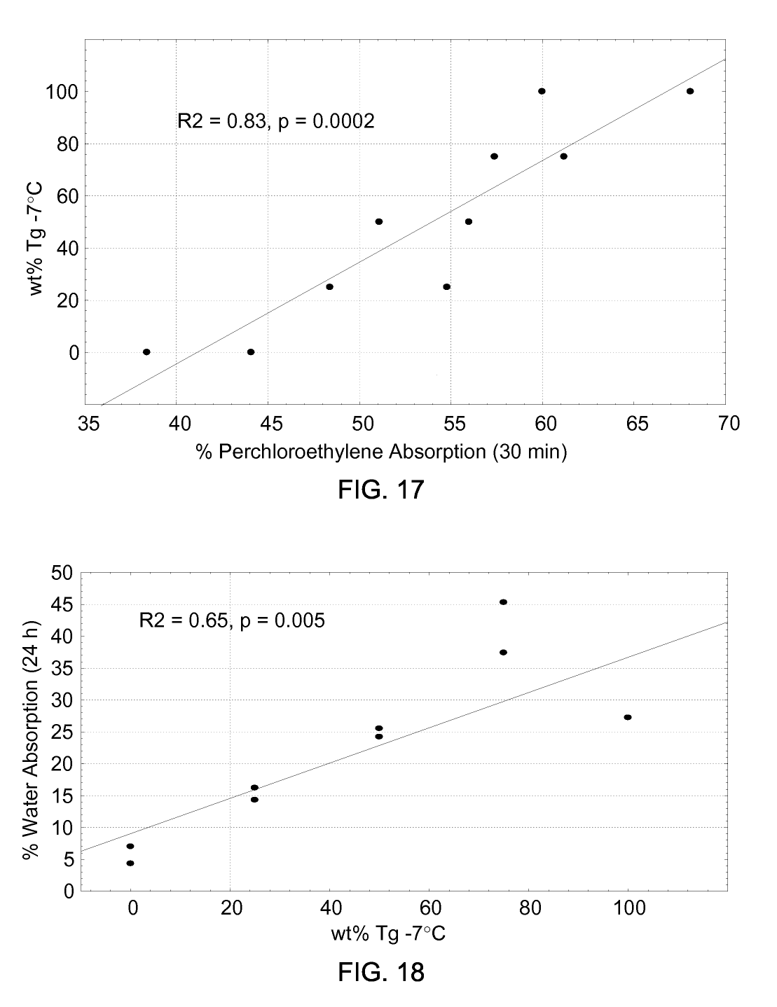

For the absorption tests in FIGS. 17-18, films were formed from the polymer dispersions. In the polychloroethylene absorption test, the films were immersed for 30 minutes in an excess of perchloroethylene at room temperature. The measurement was made by measuring the weight of the film before and after immersion in perchloroethylene and determining the percentage increase in weight after immersion in perchloroethylene. For the water absorption test, the film was immersed for 24 hrs in an excess of water at room temperature and the percentage increase was measured in the same manner described for the polychloroethylene absorption. FIG. 17 shows wt % −7° C. T_{g} polymer vs. perchloroethylene absorption (%) (described above). FIG. 18 shows water absorption (%) (described above), on the y axis with wt % −7° C. T_{g} polymer on the x axis.

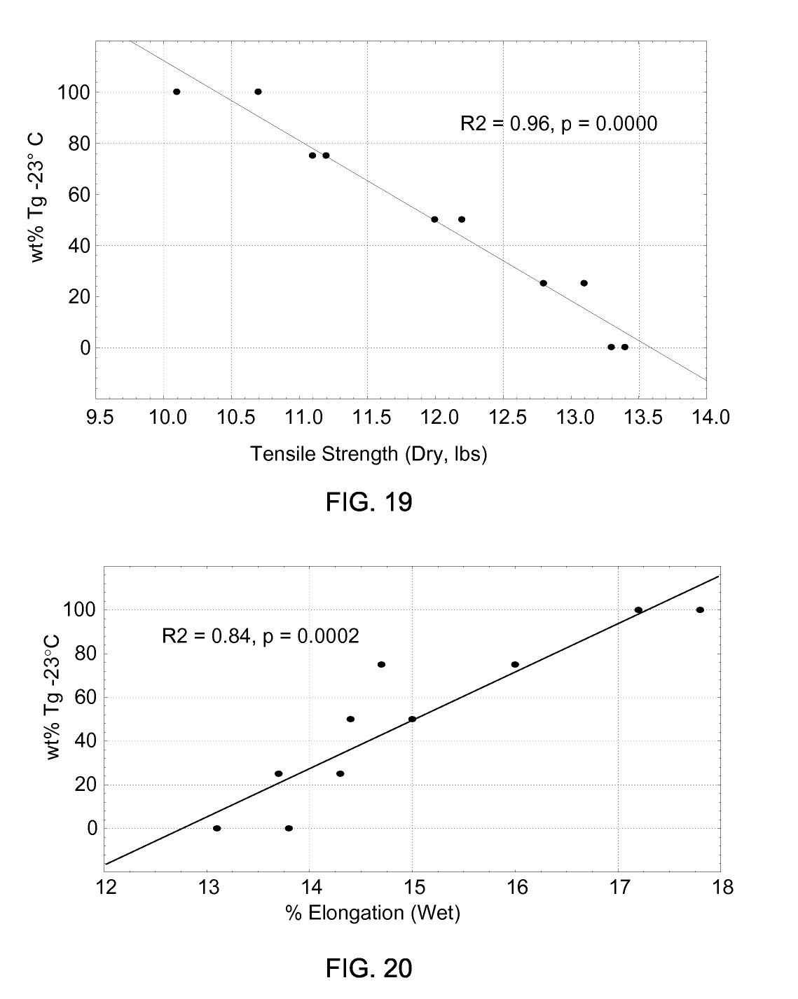

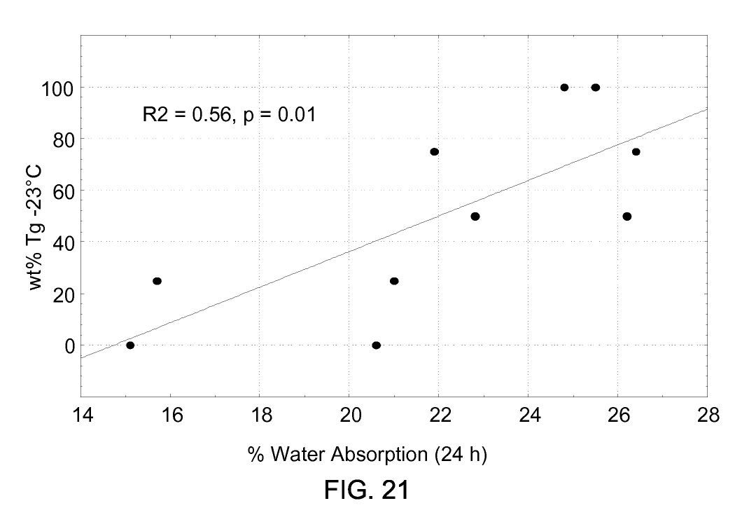

FIGS. 19-21 show dry tensile strength, % elongation (wet), and water absorption (described above) for blended fiber bonding compositions with medium/low T_{g} polymers as a function of wt % of the −23° C. T_{g} component in the dispersion. FIG. 19 shows wt % −23° C. T_{g} component in a binary mixture of −23° C. T_{g}/−7° C. T_{g} (medium/low T_{g} polymer dispersions) vs. dry tensile strength (lbs). FIG. 20 shows wt % −23° C. T_{g} component in a binary mixture of −23° C. T_{g}/−7° C. T_{g} (medium/low T_{g} polymer dispersions) vs. percent elongation (wet). FIG. 21 shows wt % −23° C. T_{g} component in a binary mixture of −23° C. T_{g}/−7° C. T_{g} (medium/low T_{g} polymer dispersions) vs. % water absorption.

Good correlations and linear models were established for tensile properties and water/solvent resistance for both high/medium and medium/low polymer blends. Analysis of blended fiber bonding compositions by differential scanning calorimetry revealed a peak for each of the different T_{g} polymers present in the composition.

The compositions and methods of the appended claims are not limited in scope by the specific compositions and methods described herein, which are intended as illustrations of a few aspects of the claims and any compositions and methods that are functionally equivalent are intended to fall within the scope of the claims. Various modifications of the compositions and methods in addition to those shown and described herein are intended to fall within the scope of the appended claims. Further, while only certain representative composition materials and method steps disclosed herein are specifically described, other combinations of the compositions materials and method steps also are intended to fall within the scope of the appended claims, even if not specifically recited. Thus, a combination of steps, elements, components, or constituents may be explicitly mentioned herein; however, other combinations of steps, elements, components, and constituents are included, even though not explicitly stated. The term “comprising” and variations thereof as used herein is used synonymously with the term “including” and variations thereof and are open, non-limiting terms. Although the terms “comprising” and “including” have been used herein to describe various embodiments, the terms “consisting essentially of” and “consisting of” can be used in place of “comprising” and “including” to provide for more specific embodiments of the invention and are also disclosed.

What is claimed is:

1. A fiber bonding composition comprising a polymer dispersion comprising two or more of:
a first polymer selected from the group consisting of styrene acrylics and straight acrylics and having a T_{g} from about 35° C. to about 45° C.;
a second polymer selected from the group consisting of styrene acrylics and straight acrylics and having a T_{g} from about −12° C. to about −2° C.; and
a third polymer selected from the group consisting of styrene acrylics and straight acrylics and having a T_{g} from about −28° C. to about −18° C.

2. The fiber bonding composition of claim 1, wherein at least one of said first polymer, said second polymer and said third polymer that is present in the composition is a straight acrylic that is derived from monomers comprising butyl acrylate and methyl methacrylate.

3. The fiber bonding composition of claim 1, wherein at least one of said first polymer, said second polymer and said third polymer that is present in the composition is a styrene acrylic that is derived from monomers comprising butyl acrylate and styrene.

4. The fiber bonding composition of claim 1, wherein at least one of said first polymer, said second polymer and said third polymer that is present in the composition is derived from monomers including (meth)acrylonitrile.

5. The fiber bonding composition of claim 1, wherein at least one of said first polymer, said second polymer and said third polymer that is present in the composition has a (meth)acrylonitrile content of from about 5 wt % to about 15 wt %.

6. The fiber bonding composition of claim 1, wherein at least one of said first polymer, said second polymer and said third polymer that is present in the composition is derived from monomers including an internal crosslinker.

7. The fiber bonding composition of claim 6, wherein the internal crosslinker is selected from the group consisting of di(meth)acrylates, tri(meth)acrylates, and mixtures thereof.

8. The fiber bonding composition of claim 1, further comprising an external crosslinker.

9. The fiber bonding composition of claim 8, wherein the external crosslinker comprises N-methylol (meth)acrylamide.

10. The fiber bonding composition of claim 1, wherein at least one of said first polymer, said second polymer and said third polymer that is present in the composition is derived from a crosslinker in an amount from about 0.2 wt % to about 1.5 wt %.

11. The fiber bonding composition of claim 1, comprising:
5-95% of said first polymer;
5-95% of said second polymer; and
0-25% of said third polymer,
by weight based on the total polymer content.

12. The fiber bonding composition of claim 1, wherein said first polymer, said second polymer, and said third polymer are derived from monomers comprising (meth)acrylic acid and/or esters thereof, (meth)acrylonitrile, crosslinkers, and optionally vinyl aromatic monomers.

13. The fiber bonding composition of claim 1, wherein said first polymer, said second polymer and said third polymer are derived from monomers comprising butyl acrylate, acrylonitrile, butanediol diacrylate, and one or more of styrene and methyl methacrylate.

14. The fiber bonding composition of claim 1, wherein the T_{g} of the first polymer is from about 38° C. to about 42° C., the T_{g} of the second polymer is from about −9° C. to about −5° C., and the T_{g} of the third polymer is from about −25° C. to about −21° C.

15. The fiber bonding composition of claim 1, wherein the composition includes from about 1 wt % to about 30 wt % urea formaldehyde resin, melamine formaldehyde resin, or mixtures thereof.

16. The fiber bonding composition of claim 1, wherein the gel content of the polymers included in the composition are from about 60% to about 90%.

17. The fiber bonding composition of claim 1, wherein the composition comprises a mixture of two or more of:
(i) a first polymer dispersion comprising a first polymer selected from the group consisting of styrene acrylics and straight acrylics and having a T_{g} from about 35° C. to about 45° C.;
(ii) a second polymer dispersion comprising a second polymer selected from the group consisting of styrene acrylics and straight acrylics and having a T_{g} from about −12° C. to about −2° C.; and
(iii) a third polymer dispersion comprising a third polymer selected from the group consisting of styrene acrylics and straight acrylics and having a T_{g} from about −28° C. to about −18° C.

18. A method of making a fiber bonding composition, the method comprising:
(i) selecting two or more polymers from the group consisting of:
(a) a first polymer selected from the group consisting of styrene acrylics and straight acrylics and having a T_{g} from about 35° C. to about 45° C.;
(b) a second polymer selected from the group consisting of styrene acrylics and straight acrylics and having a T_{g} from about −12° C. to about −2° C.; and
(c) a third polymer selected from the group consisting of styrene acrylics and straight acrylics and having a T_{g} from about −28° C. to about −18° C.; and
(ii) forming a polymer dispersion comprising the polymers selected in (i).

19. A method of coating or saturating a fiber substrate, the method comprising:
(i) applying a composition to the fiber substrate, the composition comprising a polymer dispersion comprising two or more of:
(a) a first polymer selected from the group consisting of styrene acrylics and straight acrylics and having a T_{g} from about 35° C. to about 45° C.;
(b) a second polymer selected from the group consisting of styrene acrylics and straight acrylics and having a T_{g} from about −12° C. to about −2° C.; and
(c) a third polymer selected from the group consisting of styrene acrylics and straight acrylics and having a T_{g} from about −28° C. to about −18° C.; and
(ii) heating the substrate.

20. A coated or saturated fiber substrate, comprising:
(i) a fiber substrate; and
(ii) a composition bonded to the fiber substrate, the composition comprising a polymer dispersion comprising two or more of:
(a) a first polymer selected from the group consisting of styrene acrylics and straight acrylics and having a T_{g} from about 35° C. to about 45° C.;
(b) a second polymer selected from the group consisting of styrene acrylics and straight acrylics and having a T_{g} from about −12° C. to about −2° C.; and
(c) a third polymer selected from the group consisting of styrene acrylics and straight acrylics and having a T_{g} from about −28° C. to about −18° C.
